(19) United States
(12) Patent Application Publication
(10) Pub. No.: US 2014/0016324 A1
(43) Pub. Date: Jan. 16, 2014

(54) ILLUMINANT DEVICE

(71) Applicant: Ting-Kuo HSIN, Taipei City (TW)

(72) Inventor: Ting-Kuo HSIN, Taipei City (TW)

(73) Assignee: Elementech International Co. Ltd.

(21) Appl. No.: 13/547,056

(22) Filed: Jul. 12, 2012

(51) Int. Cl. F21V 23/00; F21V 3/00; F21V 9/00

(52) U.S. Cl. 362/293; 362/382; 362/363

(57) ABSTRACT

An illuminant device includes a housing, an circuit layer, at least a light emitting diode (LED) die, a driving circuit element, a plurality of electrical elements and an conductive connector. The housing has a supporting part and a platform-part connected to a side of the supporting part. The circuit layer is placed on the platform-part. The LED die is placed on the platform-part and electrically connected to the circuit layer. The driving circuit element is placed on the platform-part and electrically connected to the circuit layer. The electrically elements are placed on the platform-part and electrically connected to the circuit layer. The conductive connector is connected to another side of the supporting part.

### BACKGROUND OF THE INVENTION

1. Field of the Invention

The present invention relates to an illuminant device, especially to an illuminant device using light emitting diode as light source.

2. Description of Prior Art

Light emitting diodes (LEDs) have the advantages of small volume, long lifetime, difficulty damage, without mercury and lower power consumption. They are gradually replacing the fluorescent tubes and incandescent lamps and widely used in indoor or outdoor lighting and decorative lighting.

However, in comparison to other lighting source, LEDs with higher power are more prone to a problem of heat dissipation. The main reason is that the heat of the LEDs cannot be dissipated through infrared radiation. Moreover, the multiple packages of the LEDs make junction thermal resistances at different junctions such that the LEDs cannot effectively dissipate heat. In general, over-temperature operation makes the LEDs reduce light output (light decay), color shift and accelerate aging to shorten the lifetime of the LEDs.

In order to increase the effect of heat dissipate, the housing of conversional LED lamps is made of metal with high thermal conductive, such as aluminum, to quickly conduct heat generated by the LED lamp. However, metal is also with high electrical conductive that may cause electric shock when use replacing or touching the LED lamps.

### SUMMARY OF THE INVENTION

It is an object of the present invention to provide an illuminant device, the housing of the illuminant device is made of ceramic material with good thermal conductive and isolating property.

Accordingly, the illuminant device includes a housing, a circuit layer, at least a LED die, a driving circuit element, a plurality of driving circuit element and a conducting connector. The housing has a supporting part and a platform-part connected to the supporting part. The circuit layer is placed on the plate-from part. The LED die is placed on the platform-part and electrically connected to the circuit layer. The driving circuit element is placed on the platform-part part and electrically connected to the circuit layer. The electrical elements are placed on the platform-part and electrically connected to the circuit layer. The conducting connector is disposed on another side of the supporting part.

The housing of the present invention is made of ceramic powder by sintering, which has good thermal conductivity for quickly conducting heat generated by the LED die, the driving circuit element and the electrical elements. The housing also has high isolating property for preventing users from getting electric shock so as to increase using safety.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of an illuminant device according to a first embodiment of the present invention.

FIG. 2 is a sectional view of the illuminant device according to the first embodiment of the present invention.

FIG. 3 is a perspective view of an illuminant device according to a second embodiment of the present invention.

FIG. 4 is a partially cross sectional view of the illuminant device according to the second embodiment of the present invention.

FIG. 5 is a perspective view of an illuminant device according to a third embodiment of the present invention.

FIG. 6 is a sectional view of the illuminant device according to the third embodiment of the present invention.

### DETAILED DESCRIPTION OF THE INVENTION

Reference will now be made in detail to the present embodiments of the invention, examples of which are illustrated in the accompanying drawings. Wherever possible, the same reference numbers are used in the drawings and the description to refer to the same or like parts.

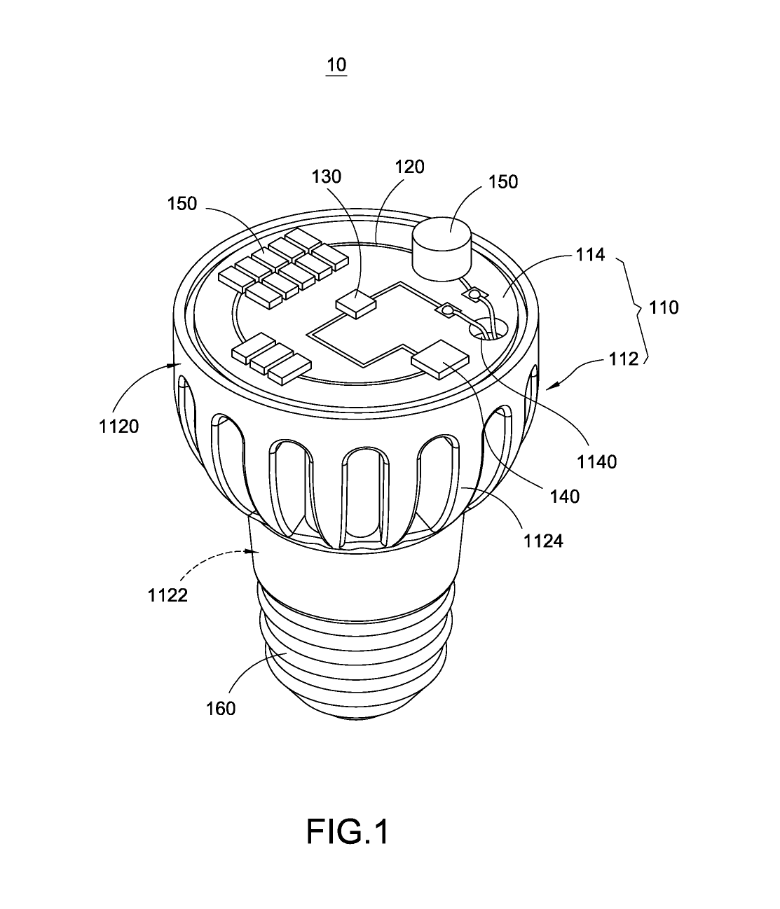

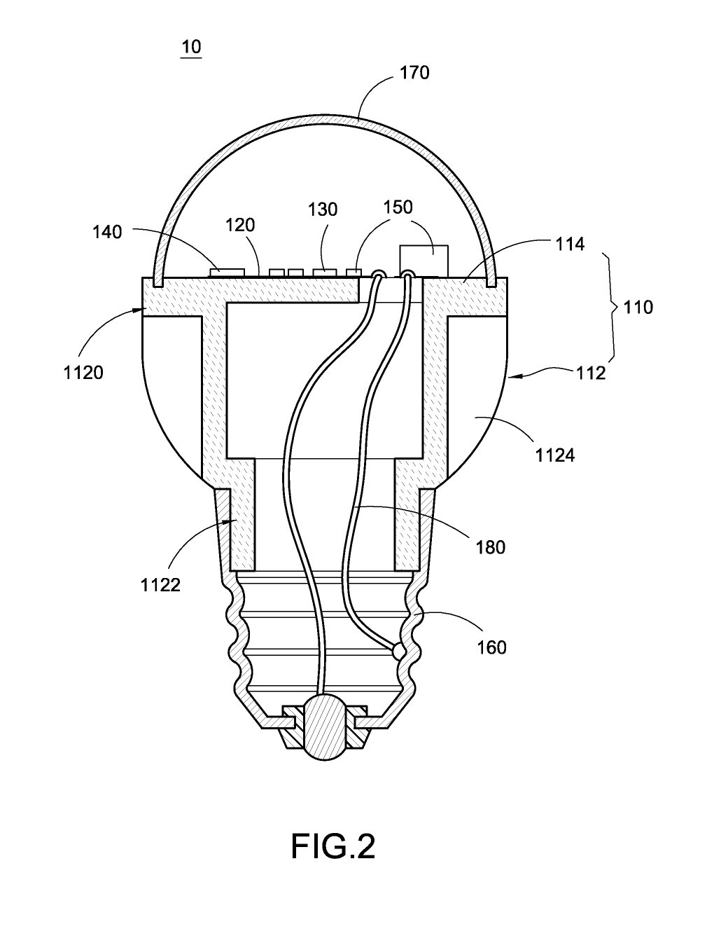

Reference is made to FIG. 1 and FIG. 2, which are respectively a perspective view and a sectional view of an illuminant device according to a first embodiment of the present invention. The illuminant device 10 includes housing 110, a circuit layer 120, at least a light emitting diode (LED) die 130, a driving circuit element 140, a plurality of electrical elements 150, an electrical connector 160 and a light-transparency shell 170.

The housing 110 is made of ceramic powder by sintering and has advantages of high stability, high isolating property and good thermal conductivity. The housing 110 includes a supporting part 112 and platform-part 114. The supporting part 112 has a first side 1120 and a second side 1122 opposite to the first side 1120. The diameter of the supporting part 112 is gradually shrunk from the first side 1120 to the second side 1122 so that the supporting part 112 is of cup-shape. The supporting part 112 further includes a plurality of fins 1124 radially extended from an external surface thereof and used for effectively conducting heat generated by the LED die 130. The fins 1124 and the supporting part 112 are preferably in one-piece form.

The platform part 112 is connected to the first side 1120 of the supporting part 112 and has at least a hole 1140. In this embodiment, the supporting part 112 and the platform-part 112 are made of the same ceramic powder, such as aluminum oxide, by sintering, and the supporting part 112 and the platform-part 114 are preferably in one-piece form so as to effectively simplify manufacturing procedure and enhance the physical strength of the housing 110.

The circuit layer 120 is placed on the platform-part 114 and made of copper, silver, or other material with electrical conductivity, and the manufacturing method of the circuit layer formed the platform-part 114 may use thick film or thin film technology by high temperature sintering or cofiring.

The LED die 130 is placed on the platform-part 114 and electrically connected to the circuit layers 120. The amount of the LED die 130 may be one or more, and in this embodiment, the amount of the LED die 130 is, for example, one. The LED die 130 may be flip chip type LED die for electrically connected to circuit layer 120, directly. Moreover, the LED die 130 may be horizontal type or vertical type LED die, and electrically connected to the circuit layer 120 by wire bonding.

The driving circuit element 140 and the electrical elements 150 are respectively placed on the platform-part 114 and electrically connected to the circuit layer 120. The driving circuit element 140 and the electrical elements 150 are collectively driving the LED die 130 and lighting the LED die 130. The electrical elements 150 may be resistor, capacitor or other passive electrical elements and collectively constitute rectification, filtering and dimming. By directly placing the LED die 130, the driving circuit element 140 and the electrical elements 150 on the platform part 114, the illuminant device 10 can dispense with additionally driving circuit within the supporting part 112, but can effectively save space and reduce the volume of the bulb lamp and cost.

The conducting connector 160 is connected to the second end 1122 of the supporting part 112. The conducting connector 160 is adapted for screwing to a lamp holder (not shown) for electrically connecting to an alternative current power. In this embodiment, the conducting connector 160 may be, but not limited to, E26 or E27 connectors. A plurality of wires 180 are connected to the conducting connector 160 and the electrical layer 120 for delivering electrical power for delivering power through the conducting connector 160 to the circuit layer 120 and conducting the driving circuit element 140, the electrical elements 150 and the LED die 130. In this embodiment, the wires 180 are disposed within the supporting part 112, one end of each wire 180 is connected to the conducting connector 160 and another end thereof is connected to the circuit layer 120 through the hole 1140 for electrically connecting the conducting connector 160 and the circuit layer 120.

The light-transparency shell 170 is disposed on first side 1120 of the supporting part 112, and assembled with the supporting part 112 and encloses the LED die 130, the driving circuit element 140 and the electrical elements 150. The light-transparency shell 170 may be selected to be transparent, translucent or matted. In this embodiment, the light-transparency shell 170 is of hemisphere shape. In the practical application, the light-transparency shell 170 may be of candlelight shape or other special shape.

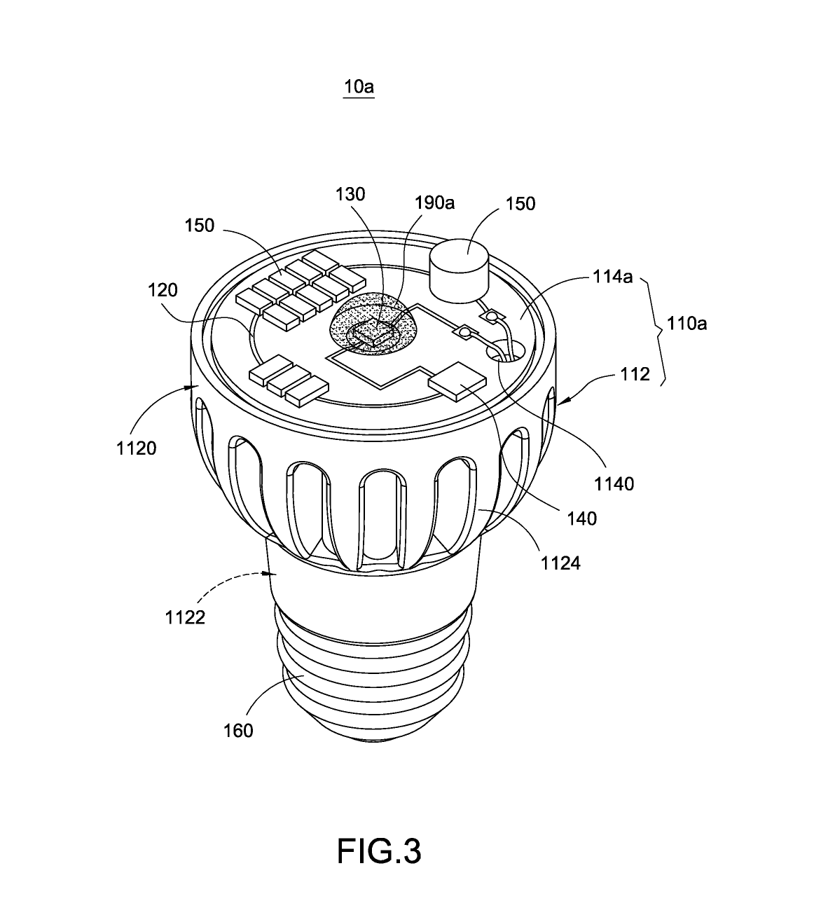

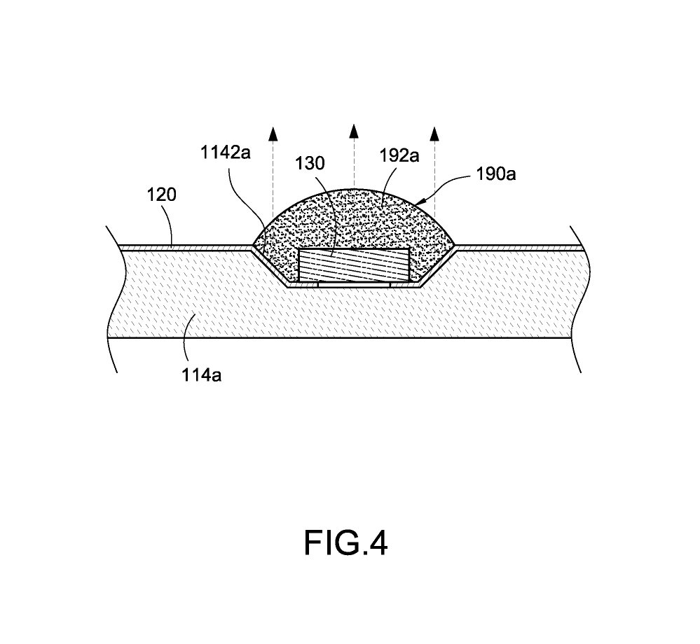

Reference is made to FIG. 3 and FIG. 4, which are a perspective view and partially sectional view of an illuminant device according to a second embodiment of the present invention. The illuminant device 10a is similar to that of first embodiment mentioned above, and wherever possible, the same reference numbers are used in the drawings and the description to refer to the same parts. It should be noted that the platform-part 114a of the housing 110a shown in FIG. 3 and FIG. 4.

The platform-part 114a has a recess 1142a. By suitable mold, the recess 1142a can be formed at the molding of the housing 110a without any other subsequent procedure, so that the manufacturing procedure can be simplified and increase yield rate.

The circuit layer 120 is placed on the platform-part 114a and extended from the platform-part 114a to the recess 1142a, and formed two independent contacts at the bottom of the recess 1142a. The illuminant element 130 is placed in the recess 1142a and electrically connected to the contacts.

The illuminant device 10a in this embodiment further includes a transmissive adhesive 190a disposed in the recess 1142a. The transmissive adhesive 190a covers the LED die 130 and is of hemisphere shape for increasing light extraction. The transmissive adhesive 190a may include a wavelength converting material 192a disposed therein. The wavelength converting material 192a is excited by partially light emitted by the LED die 130 and generates a wavelength converting light. In this embodiment, the light emitted by the LED die 130 is, for example, blue light, the wavelength converting light is, for example, yellow light, and the wavelength converting light mixes with partially blue emitting by the LED die 130 and generates white light. In the practical application, the light colors emitted by the LED die 130 and the wavelength converting light can be adjusted by demand and limitation.

The function and relative description of other components of the illuminant device 10a is the same as that of first embodiment mentioned above and not repeat them here, and the illuminant device 10a can achieve the functions as the illuminant device 10 does.

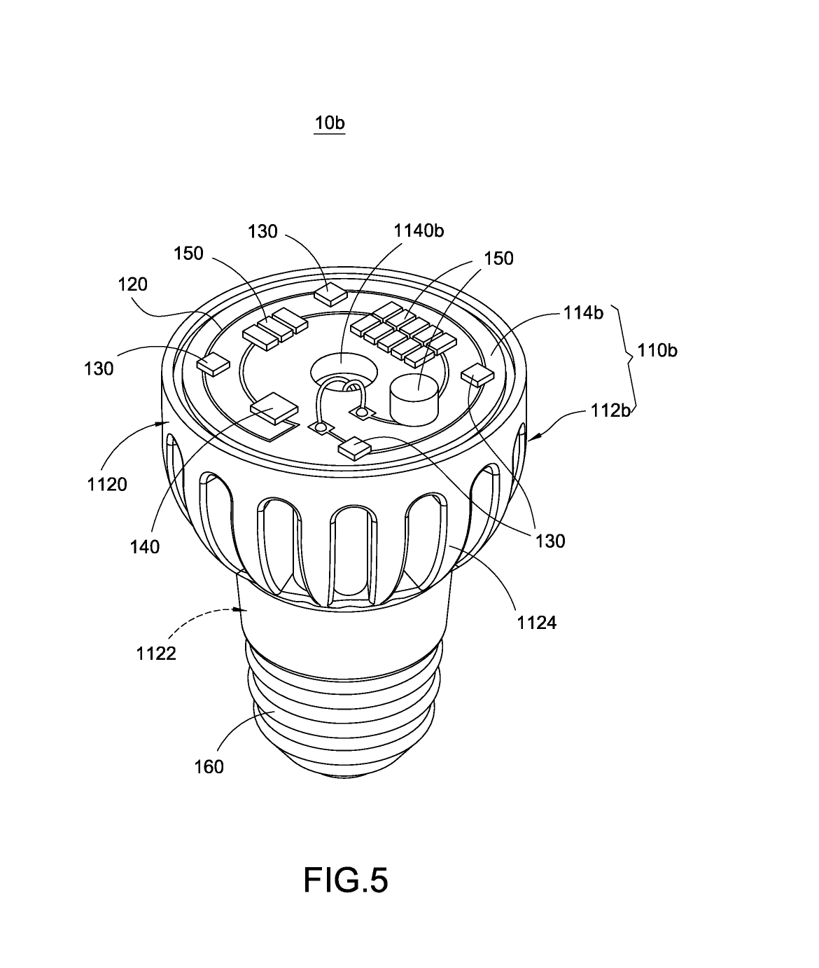

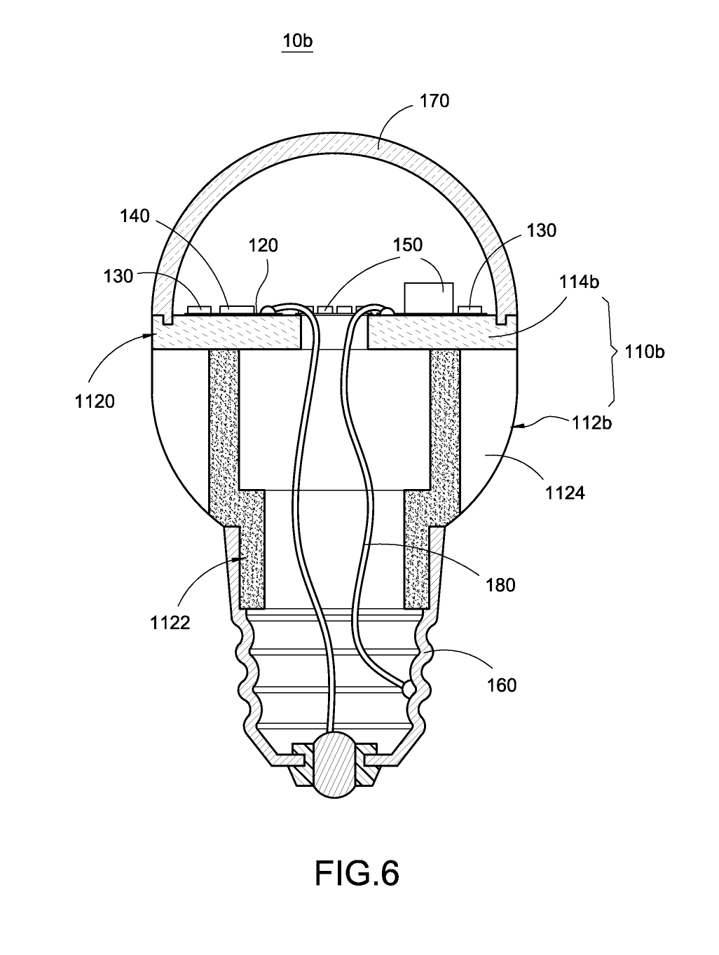

Reference is made to FIG. 5 and FIG. 6, which are a perspective view and a partially sectional view of an illuminant device according to a third embodiment of the present invention. The illuminant device 10b is similar to that of first embodiment mentioned above, and wherever possible, the same reference numbers are used in the drawings and the description to refer to the same parts. It should be noted that the housing 110b is made of at least two ceramic powders by sintering.

In this embodiment, the supporting part 112b is made of silicone carbon by sintering, the platform-part 114b is made of aluminum oxide by sintering, and the supporting part 112b and the platform-part 114b are preferably in one-piece form. By combining two different ceramic powders, the housing 110b has different colors and reach the effect of artistry. In addition, the platform-part 114b formed by the aluminum oxide with white color can reflect light emitted by the LED die 130 so that most part of light can emit toward the light-transparency shall 170. The supporting part 112b formed by silicone carbon with high hardness and black color can reduce the probability of damage by striking and prevent light from being absorbed by the silicone carbon.

In addition, an opening 1140b is formed at the center of the platform-part 114b, so that a plurality of wires 180 can electrically connected to the circuit layer 120 and the conducting connector 160 through the opening 1140b. The driving circuit element 140 and the electrical elements 150 are respectively placed on the platform-part 114b and surround the opening 1140b.

The illuminant device 10b in this embodiment further includes a plurality of LED dies 130. The LED dies 130 are placed on the platform-part 114b with the same interval and surround the driving circuit element 140 and the electrical elements 150 so as to prevent light emitted by the LED dies 130 from being blocked by the driving circuit element 140 and the electrical elements 150.

The function and relative description of other components of the illuminant device 10b is the same as that of first embodiment mentioned above and not repeat them here, and the illuminant device 10b can achieve the functions as the illuminant device 10 does.

To sun up, the housing of the present invention is made of ceramic powder by sintering, which has good thermal conductivity for quickly conducting heat generated by the LED die, the driving circuit element and the electrical elements. The housing also has high isolating property for preventing users from getting electric shock so as to increase using safety.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An illuminant device, comprising
a housing comprising a supporting part and a platform-part connected to a side of the supporting part;
a circuit layer placed on the platform-part;
at least a light emitting device (LED) die placed on the platform-part and electrically connected to the circuit layer;
a driving circuit element placed on the platform-part and electrically connected to the circuit layer;
a plurality of electrical elements placed on the platform-part and electrically connected to the circuit layer, and
a conductive connector connected to another side of the supporting part.

2. The illuminant device in claim 1, wherein the supporting part and the platform-part are in one-piece form.

3. The illuminant device in claim 2, wherein the supporting part and the platform part are made of the same ceramic powder by sintering.

4. The illuminant device in claim 2, wherein the supporting part and the platform part are made of different ceramic powders by sintering.

5. The illuminant device in claim 1, wherein the circuit layer is placed on the platform-part by cofiring.

6. The illuminant device in claim 1, wherein the platform-part has a recess.

7. The illuminant device in claim 6, wherein the circuit layer is extended from the platform-part to the recess.

8. The illuminant device in claim 6, further comprising a transmissive adhesive disposed in the recess.

9. The illuminant device in claim 8, wherein the transmissive adhesive further comprises a wavelength converting material disposed therein.

10. The illuminant device in claim 1, further comprising a light-transparency shell assembled with the housing and enclosing the LED die.

11. The illuminant device in claim 1, further comprising a plurality of wires, one end of each wire is connected to the conductive connector, and the other end of each wire is connected to the circuit layer.

12. The illuminant device in claim 11, wherein the platform-part further comprises an opening, the wires are electrically connected to the circuit layer through the opening.

13. The illuminant device in claim 1, wherein an external surface of the supporting part comprises a plurality of fins radially extended therefrom, the fins and the supporting part are in one-piece form.
